(19) United States
(12) Patent Application Publication
(10) Pub. No.: US 2026/0326600 A1
(43) Pub. Date: Oct. 22, 2026

(54) WIRELESS CHARGING STATION FOR LIGHT ELECTRIC VEHICLES WITH DYNAMICALLY ADJUSTABLE RAIL

(71) Applicant: INTELLECTULOGY SOLUTIONS INC., Victoria, British Columbia (CA)

(72) Inventors: Ishtdeep SINGH, Brampton, Ontario (CA); Mahshid SAM, Victoria, British Columbia (CA)

(73) Assignee: INTELLECTULOGY SOLUTIONS INC., Victoria, British Columbia (CA)

(21) Appl. No.: 19/486,849

(22) PCT Filed: May 22, 2024
(86) PCT No.: PCT/CA2024/050682

§ 371 Date: Nov. 21, 2025

(30) Foreign Application Priority Data
May 23, 2023 (CA) 3200294

(51) Int. Cl. B60L 53/38; B60L 53/12; B60L 53/30; B60L 53/31; B60L 53/62; B62H 3/04; H02J 50/10

(52) U.S. Cl. CPC B60L 53/38; B60L 53/12; B60L 53/305; B60L 53/31; B60L 53/62; B62H 3/04; H02J 50/10; B60L 2200/12

(57) ABSTRACT

A universal induction charging station for a light electric vehicle, the charging station comprising: a housing; a transmitter coil which is attached to the housing; a guide assembly which includes a block, an actuator motor which is mounted on the block, an actuator, which includes a distal end and a proximal end, wherein the distal end is mounted on the block or the actuator motor, a horizontally adjustable rail, which includes a first guide, which is attached to the proximal end of the actuator, a base and a second guide; a horizontal member which includes a distal end and a proximal end and which is attached to the second guide at a proximal end; a retainer, which is attached to the distal end of the horizontal member; a control system, which is housed in the housing and is in electronic communication with the transmitter coil and the actuator motor; and at least one sensor which is in electronic communication with the control system.

### FIELD

The present technology relates to a charging station for aligning and charging of light electric vehicles (LEVs) by employing a guide rail to align the light electric vehicle receiver coil with the transmitter coil of the charging station. More specifically, it is a universal induction charger for light electric vehicles.

### BACKGROUND

Currently there are various issues while charging light electric vehicles through wireless mode of transmission. One problem is misalignment of the light electric vehicle with the charging station. To achieve maximum charging efficiency while wirelessly charging, the light electric vehicle should be properly aligned with the charging station such that the transmitter coil is aligned with the receiver coil.

Kr20200027335a discloses an electric bicycle rental and charging system comprising electric bicycle holders and a wireless charging device, which can store a large number of electric bicycles and wirelessly charge the electric bicycles at the same time and prevent the stored bicycles from being stolen. According to the present invention, the electric bicycle rental and charging system comprising the electric bicycle holders and the wireless charging device comprises: a plurality of holders which hold a large number of electric bicycles having a power supply unit which supplies a magnetic field to a collection unit installed in a wheel, and a locking apparatus for preventing a theft, to fix the wheels of the electric bicycles; an awning unit installed in an upper side by being apart from the holders to prevent the holders from being damaged by rain, snow, or sunlight; and a wireless charging device which is electrically connected to the power supply unit and the locking apparatus to wirelessly prevent the charging and theft of the electric bicycles, thereby controlling the magnetic field and the locking apparatus. This does not solve the issue of aligning the transmitter coil with the receiver coil.

Kr102345358b1 discloses a mounting structure for charging an electric bicycle that can be operated by a battery, comprising: a headlight installed in a frame to secure a front view; and the battery an electric bicycle including a charging terminal formed in the headlight for charging; and a charging cradle comprising a cradle panel having at least one charging hole in which the headlight is drawn in and applying electricity to the charging terminal, and a rental device for guiding a user of a charged and usable electric bicycle. It provides a mounting structure for charging the bicycle. According to the present invention, even when the height of the mounting path changes due to problems such as failure or damage of the front wheel of the bicycle during the return process of the shared electric bicycle, the tip of the frame can be easily entered into the charging hole. This does not solve the issue of aligning the transmitter coil with the receiver coil.

What is needed is a system that allows for easy alignment of the transmitter coil of a charging station with the receiver coil of the light electric vehicle. It would be preferable if the charging system included dynamically adjustable guiding rails. It would be preferable if the distance between the guiding rails could be adjusted to secure and charge different sizes and types of light electric vehicle in the same charging station.

### SUMMARY

The present invention includes a universal induction charging station that comprises a dynamically adjustable guiding means for securing the front/rear wheel of the light electric vehicles and therefore aligning the bicycle at the desired position to achieve maximum charging efficiency. The desired position requires that the receiver coil of the light electric vehicle is in close proximity with the transmitter coil of the charging station. Once the desired position is achieved, the charging process can be initiated. The dynamically adjustable guiding means widens or narrows according to the tire size of the light electric vehicle to accommodate different sizes and geometries of a given light electric vehicle. It can also accommodate various models of light electric vehicles, for example, but not limited to electric bikes, electric scooters, electric motorcycles, electric mopeds, electric tricycles, and electric wheelchairs.

In one embodiment, a universal induction charging station is provided for a light electric vehicle, the charging station comprising: a housing; a transmitter coil which is attached to the housing; a guide assembly which includes a block, an actuator motor which is mounted on the block, an actuator, which includes a distal end and a proximal end, wherein the distal end is mounted on the block or the actuator motor, a horizontally adjustable rail, which includes a first guide, which is attached to the proximal end of the actuator, a base and a second guide; a horizontal member which includes a distal end and a proximal end and which is attached to the second guide at a proximal end; a retainer, which is attached to the distal end of the horizontal member; a control system, which is housed in the housing and is in electronic communication with the transmitter coil and the actuator motor; and at least one sensor which is in electronic communication with the control system.

In the universal induction charging station, the at least one sensor may be a position sensor.

The universal induction charging station may further comprise a load sensor, which is located on the base of the horizontally adjustable rail.

In the universal induction charging station, the control system may include a memory and a processor and is configured to receive sensor data, to control the actuator motor and to control the transmitter coil.

The universal induction charging station may further comprise a second actuator motor, wherein the horizontal member is an actuator and is attached to the second actuator motor.

In the universal induction charging station, the control system may include a wireless radio for communication with a mobile device.

The universal induction charging station may further comprise a user interface which is mounted on the housing and is in electronic communication with the control system. In another embodiment, a charging system is provided, the charging system comprising: a light electric vehicle, which is for use with a battery and which includes a frame, at least one front wheel, at least one rear wheel and a receiver coil which is mounted on the frame, the front wheel or the rear wheel and is for electrical communication with the battery; and a universal induction charging station, the universal induction charging station comprising: a housing; a transmitter coil which is attached to the housing; a guide assembly which includes a block, an actuator motor which is mounted on the block, an actuator, which includes a distal end and a proximal end, wherein the distal end is mounted on the block or the actuator motor, a horizontally adjustable rail, which includes a first guide, which is attached to the proximal end of the actuator, a base and a second guide; a horizontal member which includes a distal end and a proximal end and which is attached to the second guide at a proximal end; a retainer, which is attached to the distal end of the horizontal member; a control system, which is housed in the housing and is in electronic communication with the transmitter coil and the actuator motor; and at least one sensor which is in electronic communication with the control system.

In another embodiment, a method of charging a light electric vehicle is provided, the method comprising: selecting the system described above; providing the light electric vehicle with the battery; placing at least the wheel that retains the receiver coil on the horizontally adjustable rail; the guide assembly adjusting a position of the wheel retaining the receiver coil, as needed; the at least one sensor concomitantly reporting the position of the receiver coil in relation to the transmitter coil; and the control system instructing the transmitter coil to initiate charging, thereby charging the light electric vehicle.

The method may comprise placing both the front wheel and the rear wheel on the horizontally adjustable rail.

In another embodiment, a method of charging a light electric vehicle is provided, the method comprising: selecting the universal induction charging station described above; selecting a light electric vehicle which includes a frame, a battery which is mounted on the frame, at least one front wheel, at least one rear wheel and a receiver coil which is mounted on either the front wheel or the rear wheel and is in electrical communication with the battery; placing the wheel that retains the receiver coil on the horizontally adjustable rail; the guide assembly adjusting a position of the wheel retaining the receiver coil, as needed; the at least one sensor concomitantly reporting the position of the receiver coil in relation to the transmitter coil; and the control system instructing the transmitter coil to initiate charging, thereby charging the light electric vehicle.

### FIGURES

FIG. 1 is a schematic of the universal induction charging station of the present technology.

FIG. 2 is a schematic of an exemplary light electric vehicle.

FIG. 3 is a rear elevation view of the guide assembly, with a front wheel of a light electric vehicle in place.

FIG. 4 is an isometric view of the universal induction charging station with a front wheel of a light electric vehicle in place.

FIG. 5 is a schematic of the circuitry of the charging system.

FIG. 6 is a flow diagram of the method of the present technology.

FIG. 7 shows the welcome page.

FIG. 8 shows the user command page.

FIG. 9 shows the first page of the mobile device application.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### DEFINITIONS

Mobile device—in the context of the present technology a mobile device is a cellular phone, a smart phone, a tablet, a laptop, wearable computing device, personal digital assistant, mobile Internet device, notebook, netbook, smart device and any computing device that is either hand-held or can easily be held by an individual.

Computing device—in the context of the present technology, a computing device includes at least one processor, a network adapter, and computer-readable storage media. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. Examples of output devices that can be used to provide a user interface or display screens for visual presentation of output and speakers or other sound generating devices for audible presentation of output.

Communication network—in the context of the present technology a communication network includes, but is not limited to a wireless fidelity (Wi-Fi [IEEE 802.11]) network, a light fidelity (Li-Fi) network, a satellite network, the internet, a cellular data network, a local area network (LAN), a wireless local area network (WLAN), or any combination thereof. The network adapter of the computing device communicates via the communication network.

Computer executable instructions—in the context of the present technology, computer executable instructions include software, including as application software, system software, firmware, middleware, embedded code, or any other suitable type of computer code and also may be compiled as executable machine language code or intermediate code.

Computer readable media—in the context of the present technology, computer readable media includes magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. Computer-readable media is non-transitory and has at least one physical, structural component.

### DETAILED DESCRIPTION

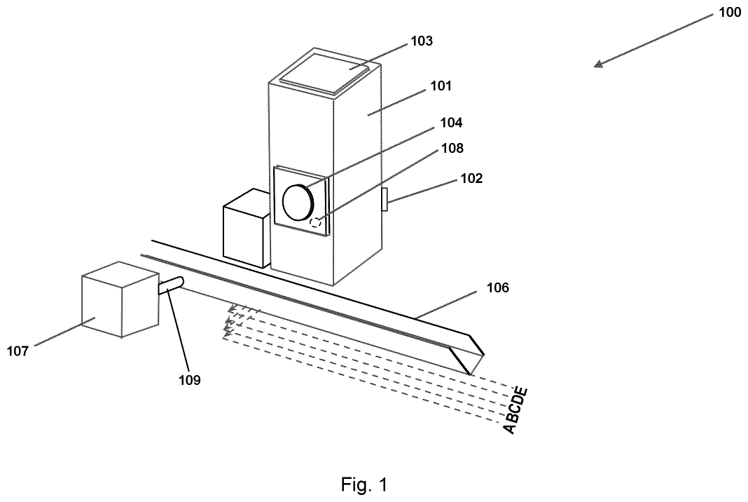

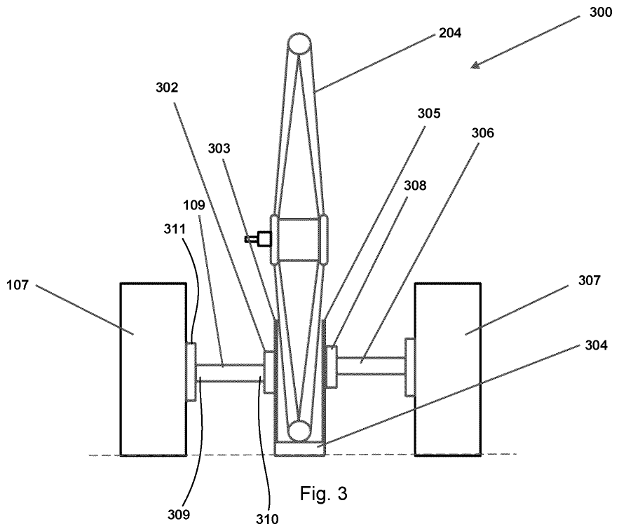

With reference to FIG. 1, a charging station, generally referred to as 100, includes a housing 101, a power connection 102 extending outward from the housing 101, a screen 103 to receive user instructions and display charging status, a transmitter coil 104, an adjustable rail 106 for securely engaging the light electric vehicle, a block 107, a position sensor 108, which can be an inductive proximity sensor, an actuator 109, which is attached to the block 107 and an actuator motor 311 (as shown in FIG. 3). The actuator 109, under control of the actuator motor 311 changes the width of the adjustable rail 106 as shown as a, b, c, d, e based on the user's instructions. The user enters the instructions on the screen 103 or through a user interface application.

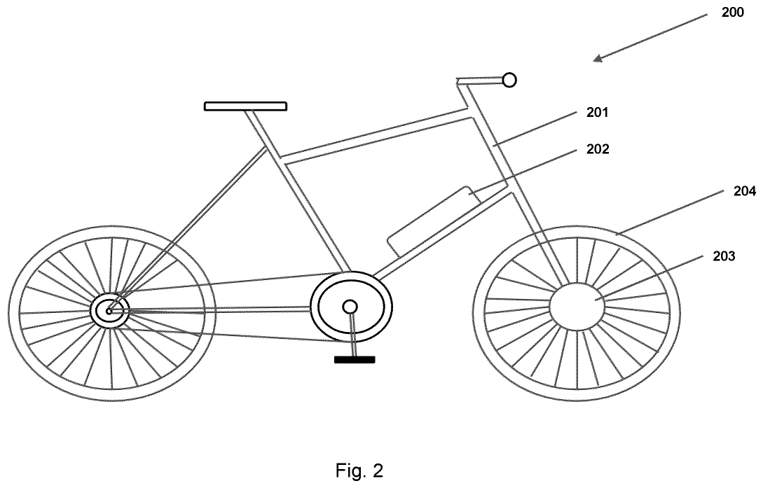

With reference to FIG. 2, a two wheeled light electric vehicle, generally referred to as 200 comprises a frame 201, a battery 202, a receiver coil 203, a front wheel 204 with a hub upon which the receiver coil 203 is mounted. In an alternative embodiment, the receiver coil 203 is mounted on the hub of the rear wheel. In another alternative embodiment, the receiver coil 203 is mounted elsewhere on the light electric vehicle 200, for example, the frame 201.

Stated more specifically, the receiver coil 203 is aligned with the transmitter coil 104 of the charging station 100 to initiate the charging process by receiving the electromagnetic wave energy and converting the input energy to a charging current and supplying the current to the battery 202 of the light electric vehicle 200.

FIG. 3 shows a rear elevation of the guide assembly, generally referred to as 300, with the front wheel 204 in place. The guide assembly 300 is designed to dynamically adjust to accommodate various wheel sizes, facilitating precise alignment for optimal energy transfer. The guide assembly 300 consists of the block 107, an actuator 109, which includes a distal end 309 and a proximal end 310, a first collar 302, the adjustable rail 106 (which includes a first guide 303, a base 304 and a second guide 305), a fixed horizontal member 306, which includes a distal end and a proximal end, a block 307, and a second collar 308. An actuator motor 311 is housed in or on the block 107. In one embodiment the actuator 109 is a threaded member and is under motive control of the actuator motor 311. The block 307 act as a retainer for the fixed horizontal member 306. In an alternative embodiment, the housing 101 is the retainer. The rotational motion of the actuator motor 311 is translated into the linear motion which moves the first guide 303 in a horizontal direction. When the actuator motor 311 is activated, its rotational motion is transmitted to the actuator 109 which advances longitudinally thereby causing the first locking collar 302 and the first guide 303 to be pushed or pulled transversely by the motion of the actuator motor 311. In an alternative embodiment, the fixed horizontal member 306 and the block 307 are replaced with a motor and another actuator, hence both the first guide 303 and the second guide 305 are moveable. In another embodiment, the actuator 109 is a pneumatic ram or a hydraulic ram and a pump under motive control of the actuator motor 311. The actuator is mounted on the block 107. In yet another embodiment, the actuator 109 is a telescoping member. In this figure, the transmitter coil 104 is located in front of the inner block 307. In all embodiments, the adjustable rail 106 of the guide assembly 300 retains the light electric bike wheel 204 snugly in place and in correct alignment with the transmitter coil 104, thereby allowing for efficient charging.

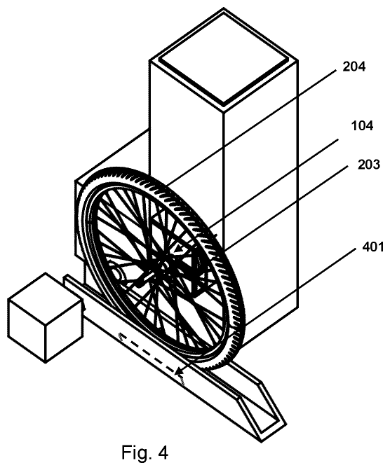

As shown in FIG. 4, the wheel 204 of the light electric vehicle 200 is engaged in the dynamically adjustable guide assembly 300 of the charging station 100. A load cell 401 determines the presence of the wheel 204. The load cell 401 may be a microswitch or an electrode which is placed on the underside the base 304 of the guide assembly 300 for detecting the presence or absence of the two wheeled light electric vehicle 200 wheel 204. Once the wheel 204 is detected, the control system notifies the position sensor 108, which then determines the alignment of the light electric vehicle 200. Once the wheel 204 is correctly positioned, the position sensor 108 notifies the control system, which then initiates charging of the battery 202. If the receiver coil 203 is mounted on the frame 201, then both the front wheel 204 and the rear wheel are engaged by the guide assembly 300.

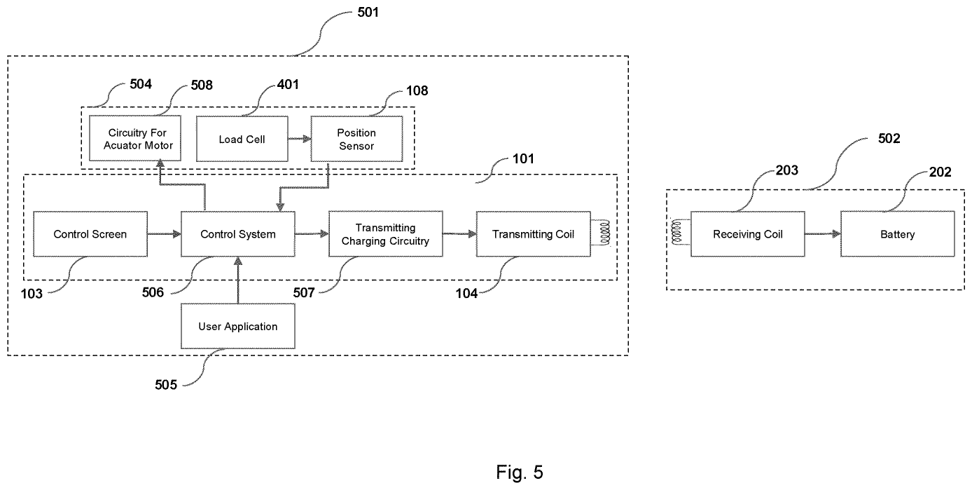

As shown in FIG. 5, the position sensor 108 transmits a sensing signal to the control system 506. As a result, the control system 506 determines that the light electric vehicle wheel 204 has been correctly placed within the charging station 100 and therefore sends the sensing signal to the transmitter charging circuitry 507. In response to the signal, the transmitter charging circuitry 507 converts the current from a power source such as solar, or electrical grid source to a high-frequency current and supplies the current to the transmitter coil 104 which further induces the magnetic field to generate a power inside the receiver coil 203 that further charges the battery 202 of the light electric vehicle 200.

FIG. 5 also shows the overall construction of the circuitry involved in the charging system that comprises a transmitter side 501 and a receiver side 502. As illustrated, the transmitter side 501 further comprises the position sensor 108, guide assembly circuitry 504 and a user application 505. These are housed in the housing 101. The housing 101 also retains the control screen 103, the control system 506, the transmitter charging circuitry 507 and the transmitter coil 104. The guide assembly circuitry 504 the actuator motor circuitry 508, the load cell 401 and the position detection sensor 108.

The control system 506 includes a memory to store predetermined positions and a processor that the memory instructs. It also includes a network adapter which is preferably a wireless radio for communication with a mobile device. The control system 506 is a microprocessor, a printed circuit board or a computing device.

The control system 506 receives the user commands from the control screen 103. In an alternative embodiment, it can receive the user instructions wirelessly from the user application 505. Based on the received user instructions, the control system 506 commands the actuator motor 311 to urge the first guide 303 such that the width of the adjustable rail 106 engages the light electric vehicle and aligns the receiver coil 203 with the transmitter coil 104. During this time, the control system 506 receives sensing signals from the position sensor 108. When the light electric vehicle 200 wheel 204 is properly aligned on the base 304 of the adjustable rail 106, the control system 506 instructs the to the transmitter charging circuitry 507, which sends a high-frequency current to the transmitter coil 104. The transmitter coil 104 emits the electromagnetic force.

The receiver side 502 comprises a receiver coil 203 and battery 202. The receiver coil 203 upon receiving the electromagnetic force energy charges the battery 202 of the light electric vehicle 200.

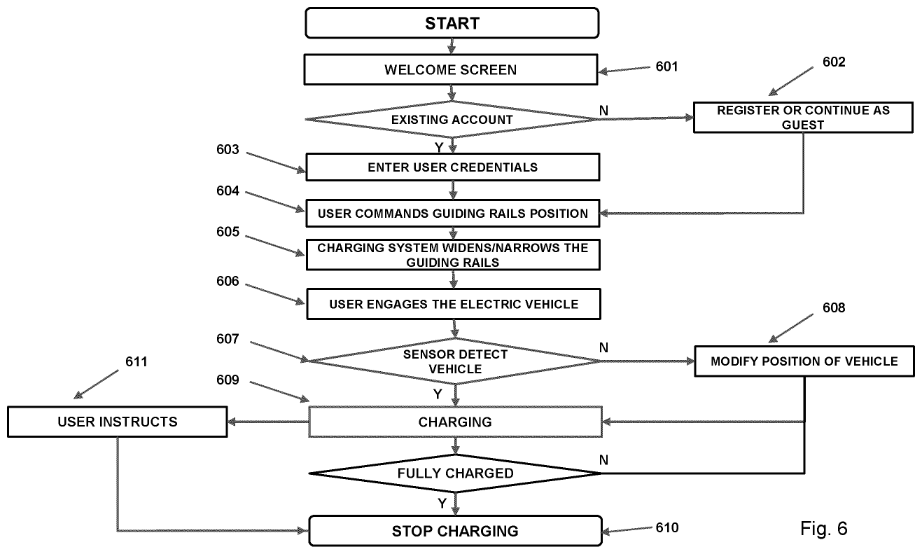

As shown in FIG. 6, at step 601, the user first arrives at the charging station the user interface will show a welcome screen providing an option to determine if the user has an existing account or not. If the user does not have an account then it moves to step 602 provided with an option to sign up or continue as a guest. If the user has an existing account, then it moves to step 603 to ask user login credentials and give access to the user's current account. Step 604, the user commands the requested position of the adjustable guide to fit in the bike inside the charging station. Step 605, the charging station system widens/narrows the adjustable guide as per the user instructions. Alternatively, the user can also use a previously saved position of the guiding means in their profile that is stored in the memory of the control system or is stored in a cloud storage or is stored on the user's mobile device. Step 606, the user engages the bike inside the adjustable guide such that the light electric vehicle is properly aligned with the charging station. Step 607, the position sensor 108 determines whether the bike is properly aligned with the charging station transmitter coil 104. If not, it moves to step 608 where a red light is lit on the control/user interface screen and prompts a message to modify the position of the light electric vehicle to properly align with the charging station. If yes, then a green signal is lit on the user interface/control screen and it moves to step 609 to start charging the light electric vehicle. Step 610, when the battery is fully charged the system stops charging. Alternatively, at step 611, the user stops the charging.

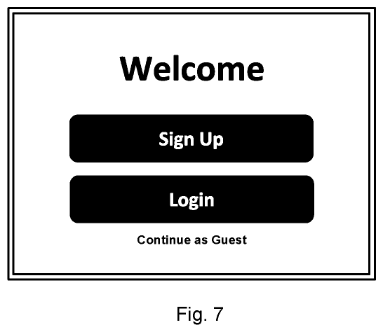

FIG. 7 shows the welcome page of the control screen interface present on the casing of the charging station. As illustrated, the control screen interface provides the option of logging in as an existing user or continuing as a guest to use the charging station.

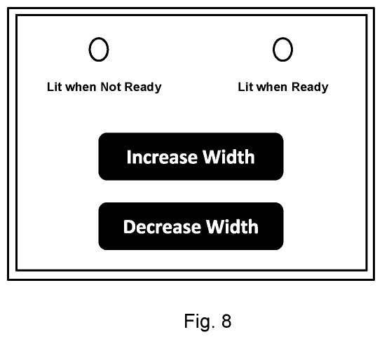

FIG. 8 shows the user commands page of the control screen that provides the user the option to increase or decrease the width of the guiding segments. The screen also includes a colour coded icon that turns red when there is no light electric vehicle or it is not properly aligned with the charging station or a foreign object is detected. The colour coded icon turns green when the light electric vehicle is aligned with the charging station and signifies that the charging station is ready to charge the light electric vehicle.

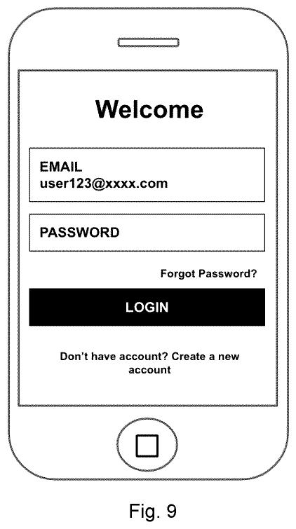

FIG. 9 shows the mobile application that can be downloaded and installed by the user to any device such as cell phone, tablet, laptop, tablet computer, etc. The user application may also be provided as a web application that can be easily accessible. As shown in FIG. 9, the user may be presented with a login screen that allows the user to register as a new user or login as an existing user.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed. Although a bicycle has been used as the light electric vehicle, as would be known to one skilled in the art, this is only exemplary and any light electric vehicle could be used.

1. A universal induction charging station for a light electric vehicle, the charging station comprising: a housing; a transmitter coil which is attached to the housing; a guide assembly which includes a block, an actuator motor which is mounted on the block, an actuator, which includes a distal end and a proximal end, wherein the distal end is mounted on the block or the actuator motor, a horizontally adjustable rail, which includes a first guide, which is attached to the proximal end of the actuator, a base and a second guide; a horizontal member which includes a distal end and a proximal end and which is attached to the second guide at a proximal end; a retainer, which is attached to the distal end of the horizontal member; a control system, which is housed in the housing and is in electronic communication with the transmitter coil and the actuator motor; and at least one sensor which is in electronic communication with the control system.

2. The universal induction charging station of claim 1, wherein the at least one sensor is a position sensor.

3. The universal induction charging station of claim 2, further comprising a load sensor, which is located on the base of the horizontally adjustable rail.

4. The universal induction charging station of claim 3, wherein the control system includes a memory and a processor and is configured to receive sensor data, to control the actuator motor and to control the transmitter coil.

5. The universal induction charging station of claim 4, further comprising a second actuator motor, wherein the horizontal member is an actuator and is attached to the second actuator motor.

6. The universal induction charging station of claim 5, wherein the control system includes a wireless radio for communication with a mobile device.

7. The universal induction charging station of claim 5, further comprising a user interface which is mounted on the housing and is in electronic communication with the control system.

8. A charging system, the charging system comprising: a light electric vehicle, which is for use with a battery and which includes a frame, at least one front wheel, at least one rear wheel and a receiver coil which is mounted on the frame, the front wheel or the rear wheel and is for electrical communication with the battery; and a universal induction charging station, the universal induction charging station comprising: a housing; a transmitter coil which is attached to the housing; a guide assembly which includes a block, an actuator motor which is mounted on the block, an actuator, which includes a distal end and a proximal end, wherein the distal end is mounted on the block or the actuator motor, a horizontally adjustable rail, which includes a first guide, which is attached to the proximal end of the actuator, a base and a second guide; a horizontal member which includes a distal end and a proximal end and which is attached to the second guide at a proximal end; a retainer, which is attached to the distal end of the horizontal member; a control system, which is housed in the housing and is in electronic communication with the transmitter coil and the actuator motor; and at least one sensor which is in electronic communication with the control system.

9. (canceled)

10. (canceled)

11. A method of charging a light electric vehicle, the method comprising:
selecting the universal induction charging station of claim 1; selecting a light electric vehicle which includes a frame, a battery which is mounted on the frame, at least one front wheel, at least one rear wheel and a receiver coil which is mounted on either the front wheel or the rear wheel and is in electrical communication with the battery; placing the wheel that retains the receiver coil on the horizontally adjustable rail; the guide assembly adjusting a position of the wheel retaining the receiver coil, as needed; the at least one sensor concomitantly reporting the position of the receiver coil in relation to the transmitter coil; and the control system instructing the transmitter coil to initiate charging, thereby charging the light electric vehicle.
